(19) United States
(12) Patent Application Publication
(10) Pub. No.: US 2005/0044274 A1
(43) Pub. Date: Feb. 24, 2005

(54) Methods of handling automated trading

(76) Inventors: Douglas R. Deming, Buchanan, VA (US); Marcus Custance, London (GB)

Correspondence Address: BROWN & MICHAELS, PC;400 M & T BANK BUILDING, 118 NORTH TIOGA ST, ITHACA, NY, 14850, US

(21) Appl. No.: 10/955,857

(22) Filed: Sep. 30, 2004

Related U.S. Application Data
(63) Continuation-in-part of application No. 09/805,235, filed on Mar. 13, 2001.
(63) Continuation-in-part of application No. 09/805,236, filed on Mar. 13, 2001.

(51) Int. Cl. G06F 15/16; G06F 15/173

(52) U.S. Cl. 709/246; 709/224; 709/203; 709/200; 709/228; 709/201; 709/202

(57) ABSTRACT

The present invention provides an interface that will capture commands and parameters between a user application and a broker application. One embodiment of the present invention discloses methods of handling automated trading. In another embodiment, methods of interfacing to the user application without modification to the user application source code are disclosed.

### REFERENCE TO RELATED APPLICATIONS

This is a continuation-in-part patent application of copending application Ser. No. 09/805,235, filed Mar. 13, 2001, entitled “COMPUTER PROGRAM FOR RECORDING AND SELECTIVE PLAYBACK OF A COMMUNICATION INVOLVING THE HYPERTEXT TRANSFER PROTOCOL”, and copending application Ser. No. 09/805,236, filed Mar. 13, 2001, entitled “HYPERTEXT TRANSFER PROTOCOL APPLICATION PROGRAMMING INTERFACE BETWEEN CLIENT-SIDE TRADING SYSTEMS AND SERVER-SIDE STOCK TRADING SYSTEMS”. The aforementioned applications are hereby incorporated herein by reference.

### BACKGROUND OF THE INVENTION

1. Field of the Invention

The invention pertains to the field of online brokerage systems. More particularly, the invention pertains to methods of interfacing to third party applications, as well as methods of handling automated trading.

2. Description of Related Art

There have been many prior art computer software programs designed for Internet interfacing patented in the past.

U.S. Pat. No. 5,754,772, Shawn T. Leaf, issued May 19, 1998, discloses a system which makes prior art On-Line Transaction Processing (OLTP) systems and their associated databases accessible using HyperText Transport Protocol (HTTP) interfaces. The response time for an on-line user seeking HTTP access to the transaction processing system is minimized by pre-establishing a transaction gateway client having a static connection to the transaction processing system.

U.S. Pat. No. 5,784,565, Donald A. Lewine, issued Jul. 21, 1998, discloses a method for determining a user's identity and creating a virtual session using the HTTP protocol without modifying the protocol or changing its stateless nature.

U.S. Pat. No. 5,901,286, Dan Danknick et al., issued May 4, 1999, discloses process steps to provide communication between a web browser capable of initiating execution of a platform-independent segment of executable code and a peripheral having an HTTP server and an SNMP agent.

In U.S. Pat. No. 5,905,908, Richard Hiers Wagner, issued May 18, 1999, an open network system supports input/output (I/O) operations for non-standard I/O devices. The system includes a server coupled to a plurality of I/O devices through an open network and an extended open system protocol that supports communication with devices that are not personal computers (PCs).

In U.S. Pat. No. 5,956,483, Thomas A. Grate et al., issued Sep. 21, 1999, a function calling protocol and methodology allow local function calls to be embedded within HTML documents, using standard HTML (HyperText Markup Language) tags, so that a user can selectively initiate the function calls while viewing the documents with a standard World Wide Web (“Web”) browser. User-invocable functions are added to Web documents without modification to either existing Web browsers or HTML.

U.S. Pat. No. 6,112,235, Jason J. Spofford, issued Aug. 29, 2000, discloses a method for remote management of a network hardware device using an industry standard internetwork protocol. A client and protocol stack are implemented on the computer network and an embedded server is installed on the network hardware device.

U.S. Pat. No. 6,128,653, David del Val et al., issued Oct. 3, 2000, discloses a method of using a Hypertext Transfer Protocol (HTTP protocol) for transmitting streamed digital media data from a server. The server is configured for coupling to a client computer via a computer network.

In U.S. Pat. No. 6,138,150, Stephen R. Nichols et al., issued Oct. 24, 2000, a personal computer or workstation running a Web browser point and click interface is used to display and send information for remotely controlling a computer such as a mainframe. In the preferred embodiment, a web site or “home-page” is constructed on a secure HTTP (hyper text transfer protocol) server which includes a Hardware Management Console (HMC).

In U.S. Pat. No. 6,151,625, Andrew G. Swales et al., issued Nov. 21, 2000, a control system includes an Internet web interface to a network of at least one programmable logic control system running an application program for controlling output devices in response to status of input devices.

There is a need in the art for an interface between the user and a third party application, which does not modify the third party application. In addition, there is a need in the art for methods of handling automated trading.

### SUMMARY OF THE INVENTION

The present invention provides an interface that will capture commands and parameters between a user application and a broker application.

One embodiment of the present invention discloses methods of handling automated trading. In another embodiment, methods of interfacing to the user application without modification to the user application source code are disclosed.

### BRIEF DESCRIPTION OF THE DRAWINGS

FIG. 1 is an illustrative view of the present invention showing communication between a user application and a broker application.

FIG. 2 is an illustrative view of a broker application using a method to uniquely identify a user application.

FIG. 3 is an illustrative view of the present invention showing a broker application providing HTTP-API services for a user trading system.

FIG. 4 is a flow chart of the initialization of HTTP-API service between a client-side trading system and a broker application.

FIG. 5 is a flow chart of the processing steps applicable to client-side trading systems having resident programming control.

FIG. 6 is a flow chart of the processing steps applicable to broker-side systems having resident programming control.

FIG. 7 is a flow chart of a method of monitoring a client's profit and loss in an embodiment of the present invention.

FIG. 8 is a flow chart of a method for handling automated trading in an embodiment of the present invention.

FIG. 9 is a flow chart of a method of making substitutions in an order in an embodiment of the present invention.

FIG. 10 is a flow chart of a method for automated end of day processing in an embodiment of the present invention.

FIG. 11 is a method of displaying order fields prior to execution in an embodiment of the present invention.

FIG. 12 is a flow chart of a method of placing stop orders in an embodiment of the present invention.

FIG. 13 is a flow chart of a method of placing stop orders in another embodiment of the present invention.

FIG. 14 is a flow chart of a method of making a user flat in at least one position in an embodiment of the present invention.

FIG. 15 is a flow chart of a method of cancelling working orders in an embodiment of the present invention.

FIG. 16 is a flow chart of a method of creating a price queue in an embodiment of the present invention.

FIG. 17 is a flow chart of a one click compression and electronic mail method in an embodiment of the present invention.

FIG. 18 is a flow chart of a one click method to provide remote technical assistance to a user in an embodiment of the present invention.

FIG. 19 is a flow chart of a method of creating a diagnostic and transaction log in an embodiment of the present invention.

FIG. 20 is a flow chart of a method of using a custom code in an embodiment of the present invention.

FIG. 21 is a flow chart of a method of providing news to a user in an embodiment of the present invention.

FIG. 22 is a flow chart of a method, which passes user specific keywords and values from a user application to an interface application without modification to the user application source code in an embodiment of the present invention.

FIG. 23 is a flow chart of a method, which retrieves user specified keywords and values using window scanning in an embodiment of the present invention.

FIG. 24 is a flow chart of a method, which retrieves user specified keywords and values using electronic mail interception in an embodiment of the present invention.

### DETAILED DESCRIPTION OF THE INVENTION

The methods and systems described herein are applicable to all tradeable products including, but not limited to, stocks, bonds, bills, mutual funds, futures, options, currencies, and commodities.

Terms and Definitions

The following terms will be used herein to describe the present invention.

A “broker” includes a broker or dealer involved in trading.

A “broker application” is an application or interface that allows a user to access, either directly or indirectly, an exchange, or over the counter electronic order matching engine that will execute orders. The term broker application includes a stockbroker trading system.

A “user application” is an application whether purchased, leased, self developed or run on a remote server that enables a user to analyze and manipulate market data to formulate trading strategies that produce executable orders or signals. Some examples of currently available user applications are: TradeStation®, MetaStock®, WealthLabs, and eSignal®. These applications routinely include an internal order status that is triggered only by price and not by actual execution by a broker application. The term user application includes a client-side trading system.

An “interface application” is a computer program that interfaces between the user application and the broker application to coordinate the communications. One example of an interface application is the TradeBolt™ system.

Buy is a command to buy the particular tradeable product. Sell is a command to sell the particular tradeable product. Sell Short is a command to sell a tradeable product, such as a stock, that the trader does not own. Cover is a command to place an order to close out a short position in a particular tradeable product.

Orders for tradeable products can have the following statuses. A “working order” is an order that has been sent to the broker application but has not yet been executed (filled). A “filled order” is an order that has been sent to the broker application and has been executed. A “rejected order” is an order that has been sent to the broker application but did not conform to some or all of the broker application order requirements, and was therefore rejected.

Some of the order types discussed in the present application are described here. A “market order” is an order that instructs an immediate execution at any available price. A “limit order” is an order that the user will specify if they want to be filled at a specific price or better. A “stop order” is an order that becomes a market order when trading occurs at or through a user specified price. A buy stop order is generally used when buying stock to limit a loss or protect a profit on short sales. A sell stop order is made to avoid further losses or to protect an existing profit. A “stop-limit order” is a stop order that becomes a limit order when trading occurs at or through the stop price. A “market if touched order” is an order that becomes a market order if and when trading occurs at a specified price.

A user is “flat” in a position when the user's net position is zero. “Long” is a market term that describes a user's net position as greater than zero. “Short” is a market term that describes a user's net position as less than zero.

One embodiment of the present invention is a method for synchronizing a user's application with a broker's application.

While there are many user applications, these applications get out of sync with the actual trades performed for the client by broker applications because the user application's order status works independently from the broker application's order status.

For example, a user application might issue a “Buy 1000 IBM at 125 Limit” and fill the order when it receives a price at 125. However, the broker application may not have filled the limit order. Thus the user application is now out of synchronization with the broker application because the user application order status is now Long 1000 IBM, but the broker application order status is zero or flat because the order did not fill.

In one embodiment, the present invention provides a method that immediately sends a market order to the broker application at the moment the user application shows the order status as filled. For example, when the user application order status reports an order “Buy ABC at 70½ Limit” as filled, the order is immediately sent to the broker application as “Buy ABC at Market”.

In addition, the present invention anticipates the need for the interface applications to provide a more secure authentication process. In such cases, the interface application will maintain the user's account number, and machine specific information, such as CPU information, system user name, hard drive information, IP address etc, or any combination thereof. The combination of information is fed into a system that generates a unique serial number that is compared to a user's account file to determine the validity of the access.

In one embodiment, the present invention provides a HTTP-API method and apparatus whereby a client trading system can communicate with a stockbroker trading system to perform predetermined functions defined by the stockbroker trading system without having the absolute need for a client-side web browser, plugins or software languages contained within the stockbroker server system.

The present invention overcomes the shortcomings of the prior art by providing HTTP-API between client-side trading systems and server-side trading systems.

Also, the present invention provides HTTP-API for generating market orders from the client-side trading system upon client-side trading system generating filled orders.

In addition, the present invention provides for server-side tradeable product trading system querying client-side system generating verifiable identification for access to server-side stored client-side HTTP-API routines.

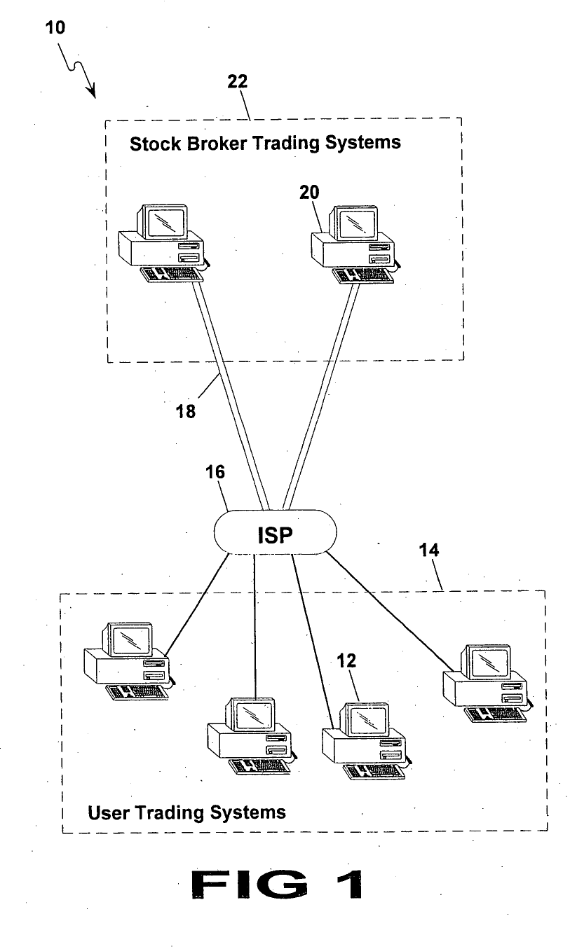

FIG. 1 through FIG. 6 illustrate an interface, which is preferably the HTTP-API, between a user application (user trading system) and a broker application (stockbroker trading system) of the present invention indicated generally by the numeral 10.

Referring to FIG. 1, users 14 having unique user trading systems communicate through an internet service provider 16 with stockbroker trading systems 22 via communication lines 18. The user 12 having a client-side trading system that makes recommendations to buy and/or sell a tradeable product, for example a stock, at a given value transmits these orders to his/her stockbroker trading system 20. While the user records the transaction as occurring, the reality is unpredictable.

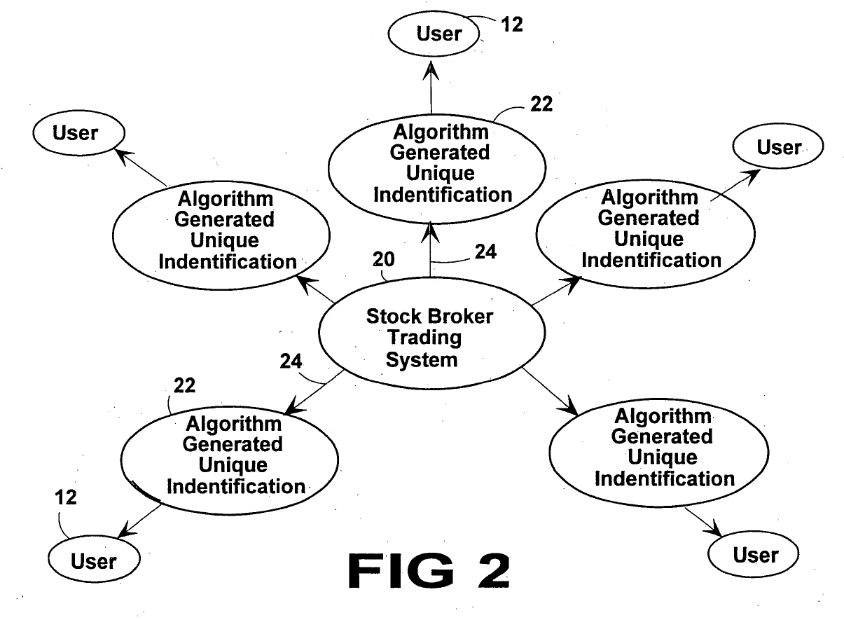

Referring to FIG. 2, the user 12 contracts with the stockbroker trading system 20 to perform buy/sell orders. The stockbroker trading system creates an account for the user by querying the user's system to create a unique customer identification based on the user's physical hardware. The stockbroker trading system 20, via communication 24 using algorithm 22 gathers information from the user's system such as CPU information, system user name, hard drive information, IP address, etc., or any combination thereof to generate a user access code.

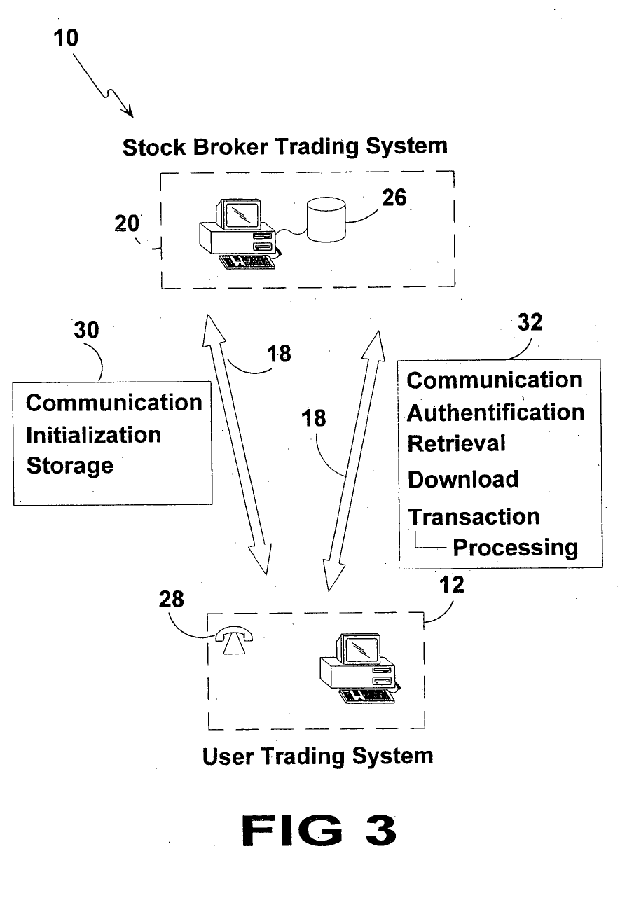

Referring to FIG. 3, the user 12, after communicating and contracting with a stockbroker trading system, can record the HTTP commands that will provide access to the broker trading system 20. The user can store the HTTP commands within their system whereby the user can transmit their buy/sell orders without the need for a web browser or other stockbroker-side software. All that would be required is the client-side means of communication 28 with their ISP which would give them direct access via 18 to the stockbroker system 20. The user 12 could also contract with the broker 20 to provide an HTTP-API access. The user 12 establishes a communication with broker 20. After authentification, the user retrieves the HTTP-API and downloads to their system from the broker system having the user HTTP-API on storage media 26. Whereupon the user can perform transaction processing with the broker system.

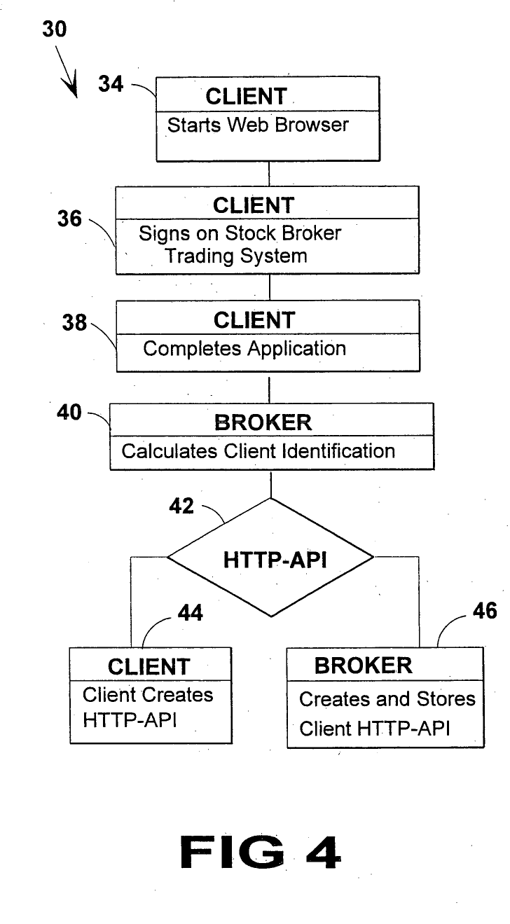

Referring to FIG. 4, the client-side 30 invokes a web browser in step 34 and signs onto a stockbroker trading system in step 36. The client completes the trading system application in step 38 whereupon the broker trading system queries the user's system to generate a client identification in step 40. The client has the option of storing the HTTP commands 42 within their own system where using the HTTP-API program can modify the stored HTTP commands to their own need in step 44. The client can also contract with the broker trading system to store the HTTP client commands in step 46.

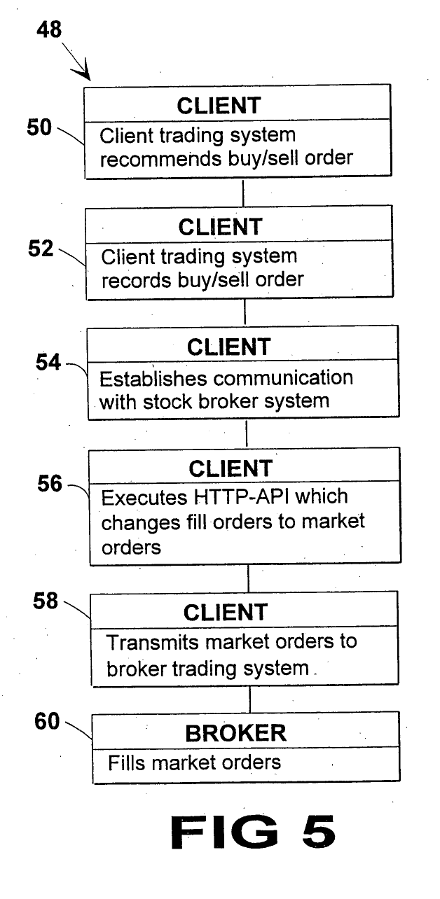

Referring to FIG. 5, the client-side trading system recommends filled orders that are transmitted to the broker system 48. The client selectively runs the user trading system that recommends buy/sell orders in step 50. The client trading system records the transactions in step 52 whereupon the client establishes communication with the stockbroker system in step 54. The client side executes the HTTP-API that changes the filled orders to market orders in step 56. The market orders are transmitted to the broker system in step 58 and they are filled by the broker system in step 60.

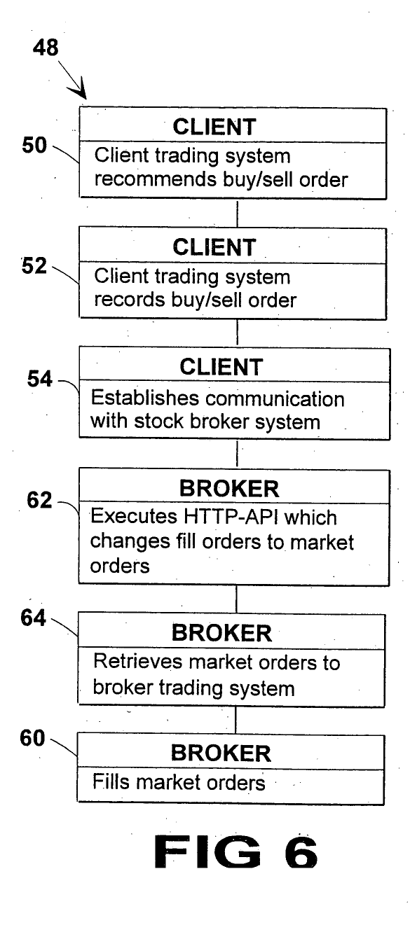

Referring to FIG. 6, the client-side trading system recommends filled orders that are retrieved the broker system in step 66. The client selectively runs the user trading system that recommends buy/sell orders in step 50. The client trading system records the transactions in step 52 whereupon the client establishes communication with the stockbroker system. The broker-side executes the HTTP-API in step 62 that changes the filled orders to market orders. The market orders are retrieved by the broker system in step 64 where they are filled by the broker system in step 60.

The following examples will further illustrate the scope of the present invention.

A user signs onto a stockbroker trading system that has the broker's web page. For the purpose of illustration it is assumed that the web page has a logon procedure whereby the user can gain access to account balance information, user portfolio list, buy/sell function enabling the user to purchase additional tradeable products and/or sell portfolio instruments and an order status function.

The present invention records the HTTP commands and associated parameters for each of the previously stated functions, Logon, Account Balance, Portfolio List, Buy/Sell and Order Status. The commands are stored whereby other software applications can incorporate these functions singularly or in total in any desired order.

Monitoring Client's Profit/Loss

This interface application will logon a user, retrieve their portfolio list, determine the profit or loss of each tradeable product in the portfolio, and close out any positions which exceed a user defined profit and/or loss.

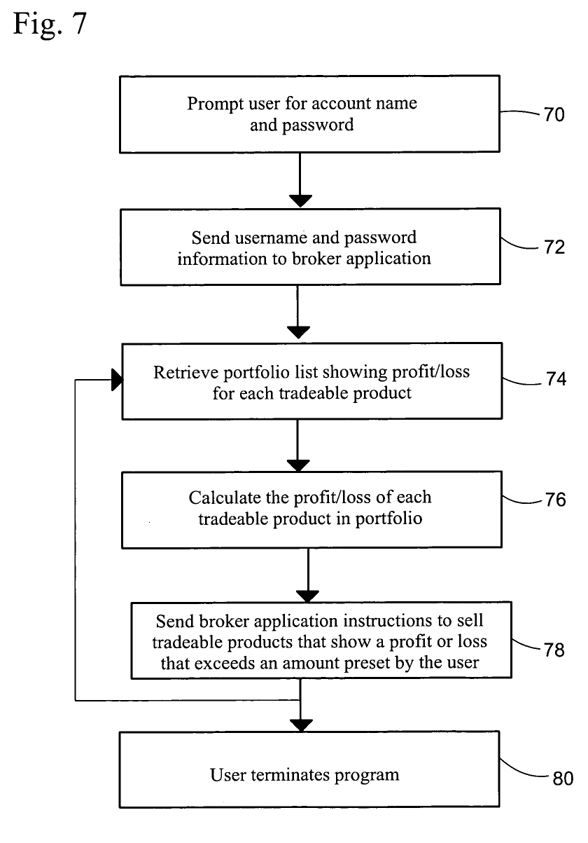

As shown in FIG. 7, the application will do the following:
Prompt user for account username and password in step 70.
Send username and password to the broker application to logon in step 72.
Retrieve the portfolio list showing profit/loss of each tradeable product in step 74.
Parse out the profit/loss of each tradeable product in the portfolio in step 76.
Send an order to offset the tradeable product that shows a profit and/or loss as preset by the user to the broker application in step 78.
Loop to step 74 until user terminates program in step 80.
   Methods for Handling Automated Trading

The present application also discloses novel methods of handling automated trading.

In these embodiments, the interface application interfaces with a user application (ex. TradeStation®, Metastock.®, WealthLabs, eSignal®, etc.) that generates buy/sell signals. The interface application will take the buy/sell signals generated by the user application and automatically place the order with the broker application. Furthermore, it also can provide the client with the following options:
a) Send a market order to the broker application at the moment the user application shows the order status as filled.
b) Convert “Limit” type orders to “Market if touched” orders.
c) Hold “Limit” type orders until market has touched “Limit” price and then sending to broker as “market” order.
d) Hold “Stop” type orders until market has touched the “Stop” price and then send to broker as “Market” order.
e) Close out all positions just before the closing of the market each day.

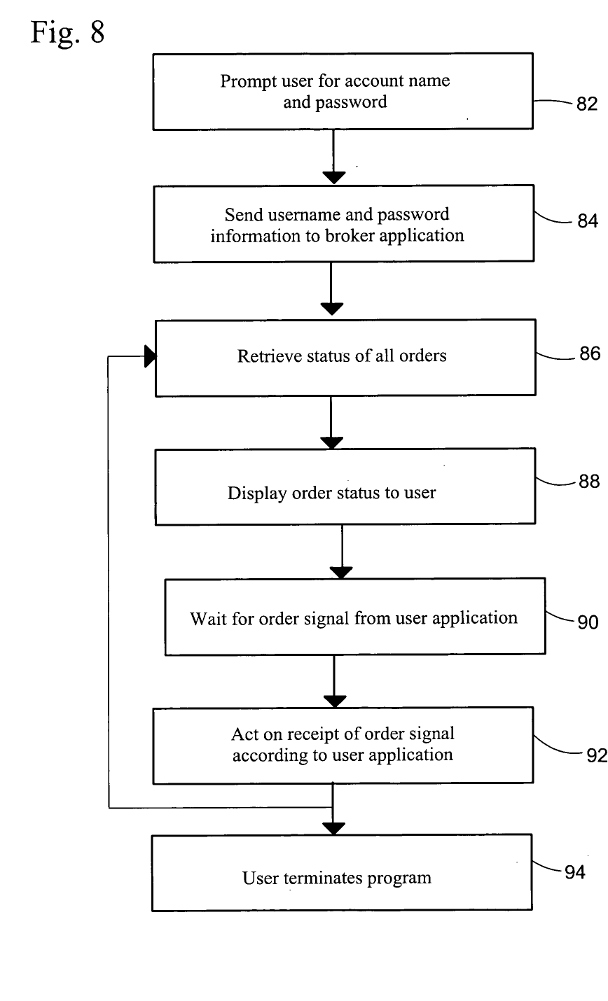

As shown in FIG. 8, the application will do the following:
Prompt user for account username and password in step 82.
Send username and password to the broker application to logon in step 84.
Retrieve broker application status of all orders in step 86.
Display broker application “Order Status” to user in step 88.
Wait for order signal from the user application in step 90.

When interface application receives an order signal from the user application, do one or more of the following in step 92:
a) Send a market order to the broker application at the moment the user application shows the order status as filled.
b) Convert “Limit” type orders to “Market if Touched” orders.
c) Hold “Limit” type orders until market has touched “Limit” price and then send to broker application as “market” order.
d) Hold “Stop” type orders until market has touched the “Stop” price and then send to broker as “Market” order.
e) Close out all positions just before the closing of the market each day.

Loop to step 86 until user terminates program in step 94.

Specific methods of handling automated trading are further discussed in detail below.

Automated Order Field Substitution

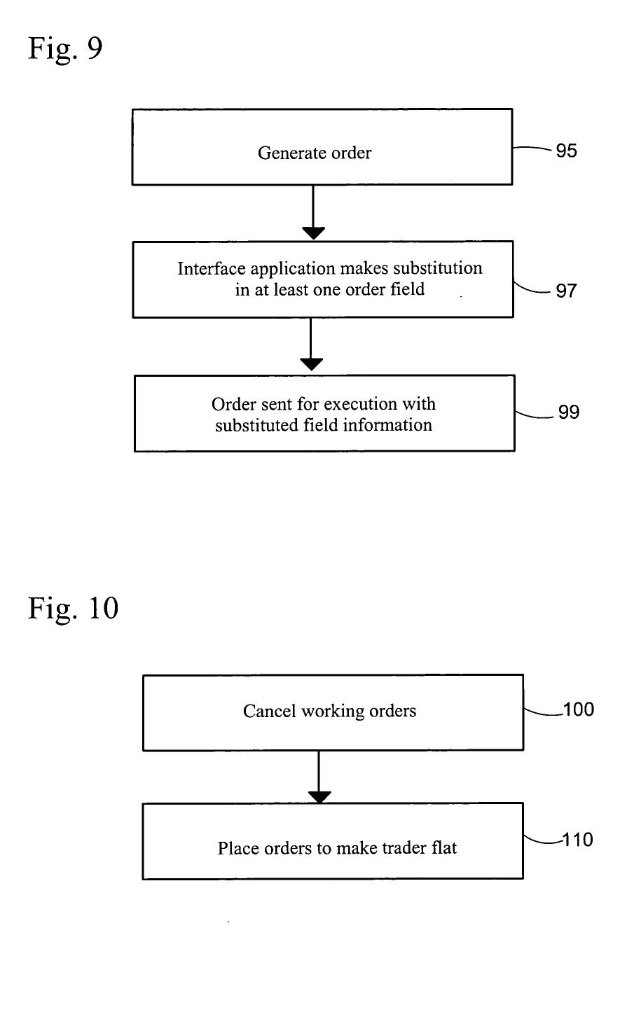

As shown in FIG. 9, this process will replace a user specified order field with a substitute and then continue to process the order as normal. The order is initially generated by the user application in step 95. The interface application makes a predefined user substitution in at least one order field in step 97. The order is then sent to the broker application for execution, with the substituted information, in step 99.

The order fields include, but are not limited to, symbol, quantity, price, order type, Order Cancel Another Group, exchange, currency, tick size, and price movement per tick.

For example, the user application could generate the following order:
“BUY 1000 IBM at MARKET”

However, the interface application can substitute the symbol field and quantity fields with a different value such as “MSFT” and 500. Thus after the substitution, the interface application would send the order to the broker application as: “BUY 500 MSFT at MARKET”

Automated End of Day Processing

In this method, shown in FIG. 10, at a user specified time of day, the interface application will cancel all working orders in the broker application in step 100 and/or will send offsetting orders to the broker application for any/all open positions in the broker application in step 110. In addition, this process can turn off or prevent the interface application from sending any further orders for the symbols affected by the end of day processing.

For example:

Assume the end of day processing takes place at: 16:14:50 and the user currently has the following orders working:
(1) “BUY 1000 IBM at 123.55 Limit”
(2) “BUY 2000 MSFT at 16.55 Stop”
(3) “BUY 4000 CPQ at 143.55 Stop-Limit”.

If the user specifies that he wants all of his working orders cancelled, then at 16:14:50 the interface application sends a cancellation command to the broker application to cancel each of the above orders.

Suppose a user has the following positions and has specified that he would like to be flat in all of his positions at the end of the day processing time:
LONG 4000 IBM
SHORT 5000 MSFT
LONG 1000 CPQ

The interface application at 16:14:50 would send the following orders to the broker application:
SELL 4000 IBM at market
BUY 5000 MSFT at market
SELL 1000 CPQ at market

Suppose the user had both the working orders and positions above at the end of the day, and specified that he wanted both his working orders cancelled and all of his positions flat at the end of the day. At the end of day processing time, the interface application would follow the two steps explained above.

Displacing Interface Application Orders for Preview Before Sending to Broker Application

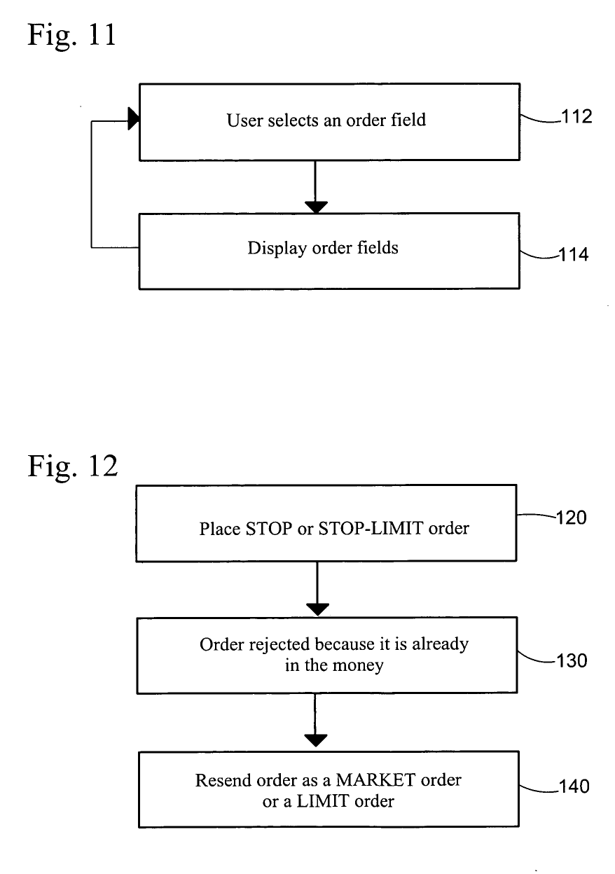

As shown in FIG. 11, this process displays the user's order in step 114 as the user manually selects the various order fields in step 112. This is displayed on the “Send Button”. The order fields are:
Command, Qty, Symbol, Price, OrderType
Command is typically: Buy, Sell, SellShort, Cover
OrderType is typically: Market, Limit, Stop, Stop-Limit, and so on

For example: An application might have a “SEND TO BROKER” button which changes as the user selects the order fields:

| Trader Action | Button Display |
|---|---|
| Selects Command: BUY | “BUY” |
| Selects Symbol: MSFT | “BUY MSFT” |
| Selects Qty: 1000 | “BUY 1000 MSFT” |
| Selects Limit Price: 123.45 | “BUY 1000 MSFT at 123.45” |
| Selects Stop Price: 120.12 | “BUY 1000 MSFT at 120.12 Stop |
| | Limit 123.45” |

Automated Handling of Rejected Stop Orders

As shown in FIG. 12, this method automatically handles rejected stop orders when an order is rejected by the broker application because it is “in the money” at time of placement. A buy stop order is in the money when the market price is above the stop order price. A sell stop order is “in the money” when the market price is below the stop order price. Rejection of stop orders “in the money” may occur when the user application automatically generates the orders, which are sent to the broker application, and the user application is unable to determine if the order is already “in the money” ahead of time. Alternatively, the price movements in the market may be so rapid that, at the time the order was sent, it was “out of the money”, but an instant later, the price moved so the order is now “in the money”.

If a user places a stop or stop-limit or any type of stop order in step 120 and the order is subsequently rejected by the broker application in step 130 because the order is “in the money”, then the interface application automatically modifies the order to a market order or a limit order “in the money” and the order is resent for execution in step 140.

To illustrate, the user application generates an order that the interface application sends to the broker application to “BUY 10 ESH04 at 1000.50 stop” and at the time the order is place and/or received, the market is trading at or above 1000.50. The broker application will reject the order because it is already in the money. This order would instantly be modified by the interface application to: “BUY 10 ESH04 at MARKET” or “BUY 10 ESH04 at 1010.00 LIMIT” and resent to the broker application as a modified order or as a new order for execution.

Handling STOP Orders When Not Supported by Broker Application

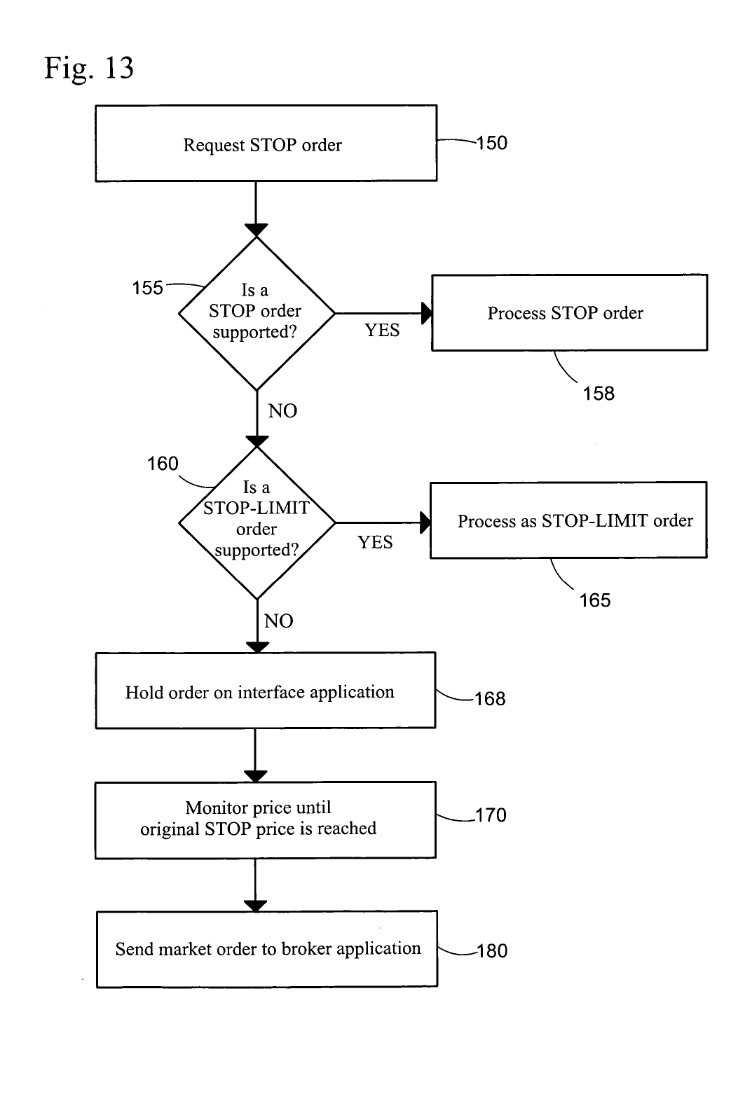

This method, shown in FIG. 13, handles stop orders when the broker application does not support this order type. The user application sends a stop order to the interface application in step 150. The interface application checks if this order type is supported by the broker application in step 155. If it is supported, then the order is processed as normal in step 158. If it is not supported, then the interface application checks if the broker application supports a stop-limit order in step 160. If a stop-limit order is supported, the interface application sends the order as a stop-limit order to the broker application in step 165. If a stop-limit order is not supported by the broker application, the interface application does not send the order to the broker application. Instead, the interface application holds the order in the interface application in step 168 and constantly monitors real time bid/ask/last (user selectable) prices in step 170, until the original order stop price is reached. Then, the interface application immediately sends a market order to the broker application in step 180.

### EXAMPLE

The user application places an order to “BUY 1000 IBM at 123.45 STOP” however, the broker application does not support the stop order type, so the interface application checks if a stop-limit type is supported. If so, then the order is sent as a stop-limit with a preset user variable for the limit price such as 2.0:
BUY 1000 IBM at 123.45 STOP LIMIT 125.45

However, if the order type stop-limit is also not supported, then the order is held in the interface application and sent as a market order as soon as the user selectable bid/ask/last price touches the original order price of 123.45.

One Button Click to Take User's Positions to Flat

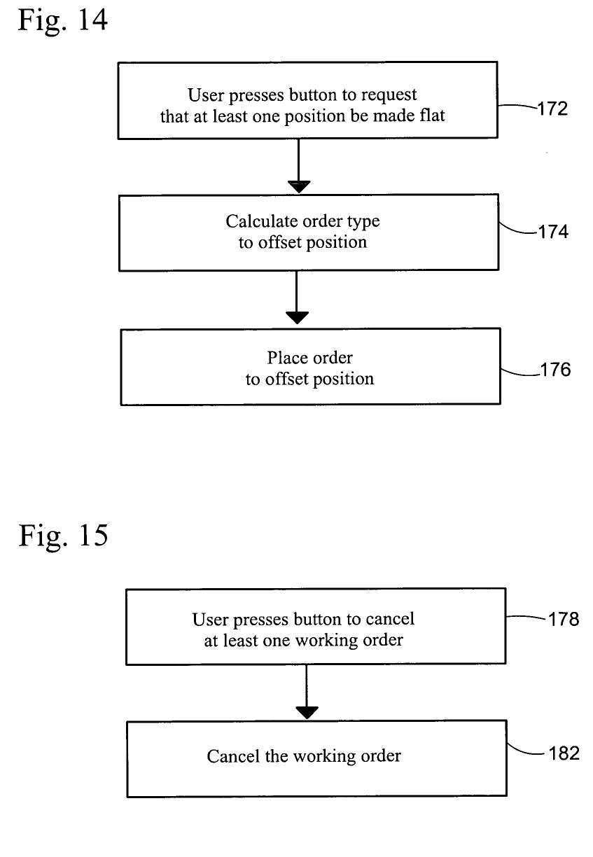

As shown in FIG. 14, this is a one button click to calculate and place an order to offset the trader's selected positions. When clicked by the user in step 172, for each user selected position, the process will calculate in step 174 and place an order in step 176 or user selected order type to offset the position when the order is executed.

### EXAMPLE

User is currently:
LONG 100 IBM
SHORT 200 MSFT

The user subsequently presses the “Close All Positions” button in the interface application, which calculates the order to offset each of the user selected positions. In this example, the user has specified market order type for both positions so the following orders are automatically sent to the broker application:
SELL 100 IBM at Market
BUY 200 MSFT at Market

One Button Click to Cancel All Working Orders

As shown in FIG. 15, this is a one button click to cancel all/selected user working orders. When clicked in step 178, for all or each user selected working orders, this process will cancel the working order in step 182.

### EXAMPLE

User's current working orders:
BUY 100 IBM at 123.45 Limit
SellShort 2000 MSFT at 321.45 Stop

User subsequently press the “Close All Working Orders” button in the interface application, which cancels the two selected working orders.

Shared Real Time Price Queue

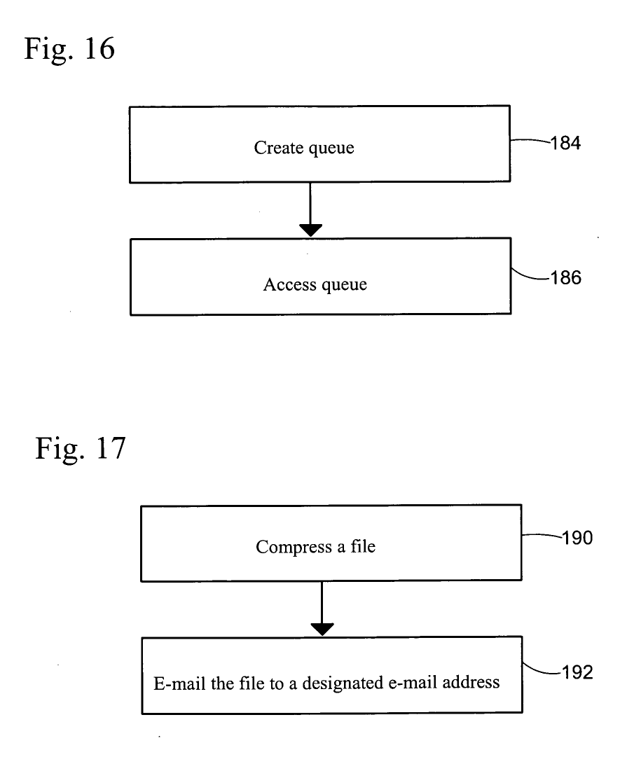

As shown in FIG. 16, this is a technique to capture real time prices in a common queue that is subsequently shared with multiple applications or processes. Each process can access the common queue at a different rate independent of the other processes and independent of the rate at which the queue is filled with new prices.

The queue created in step 184 is of a predetermined fixed or dynamic size. Each time a new price is pushed on the queue using a FIFO (First-in, First-out) method, the queue pointer is incremented by one. If the pointer exceeds the queue size, then the pointer resets to the zero element of the queue.

This queue can now be accessed in step 186 by multiple independent applications/processes each at a rate independent of one another and independent of the rate the queue is adding new prices. Each time a new process joins the queue it is assigned an independent pointer initially set to the oldest value in the queue. If the queue pointer overruns the process pointer, then the process pointer is set to the queue pointer and the data point is overwritten. As long as the process is requesting data at a faster rate than the queue is receiving data, there is neither an overrun nor loss of data.

### EXAMPLE

A real time price feed is adding prices to the queue. There are three other applications that now access this queue, all at independent rates. This allows the three other applications to share a common price feed.

One Click Compression and Email

As shown in FIG. 17, with one click, this process compresses a file in step 190 and emails it to a designated email address in step 192. For example, the user could predesignate a recipient email address and predesignate a specific target file. For example, this file could be the “diagnostic” or “transaction” log (described in more detail below) or a file containing a log of user actions and application events that needs to be reviewed by technical support staff. Some users may find it difficult to perform all of the steps of locating the file, compressing the file, attaching the file to an email, and sending the file to technical support. In this process, the user only has to click on the button. The program then (1) locates the predesignated file, (2) compresses the file, (3) creates an email, (4) attaches the compressed file to the email, (5) fills out the recipient field with technical support email, (6) fills out the email subject, (7) fills out the email body with text such as “Here is my diagnostic log for your technical support review”, and (8) sends the email.

One Click Remote Technical Assistance To Aid Technical Support to Assist User

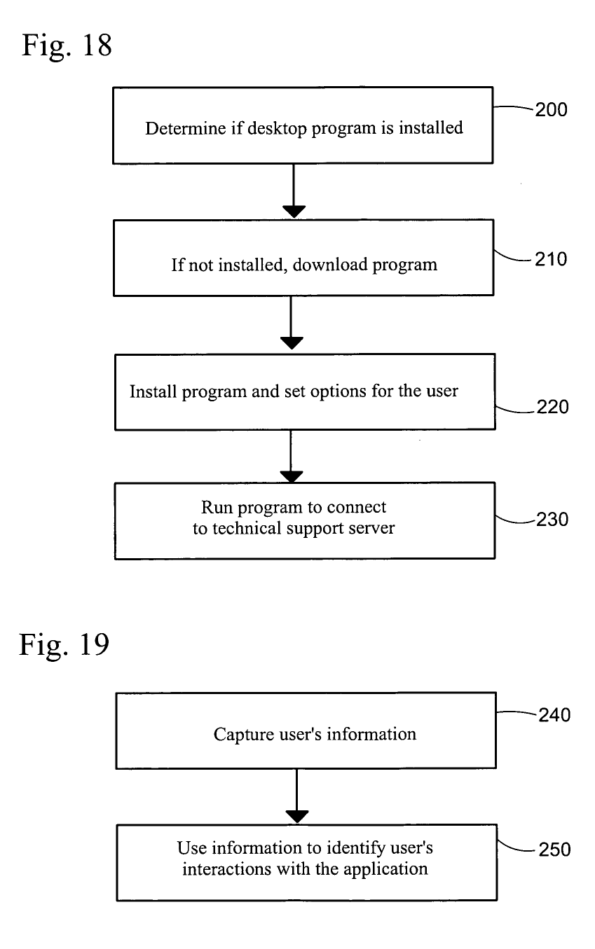

As shown in FIG. 18, with one click, this process will determine if the user has already installed a publicly available remote desktop program such as “Real VNC” in step 200. If not installed, the process will download the program from a predesignated URL in step 210 and then automatically install the remote desktop program and set various options for the end user in step 220.

Once the remote desktop program is installed or has already been installed, then the process will run the program to connect to the technical support's server allowing the technical support staff to assist the client by viewing the user's desktop in step 230.

Diagnostic and Transaction Log

FIG. 19 shows a method of capturing a user's application choices in step 240 and subsequent actions of the application. The log is then used to identify the cause and effect of a user's interaction with the application in step 250. This is specifically applied to online automatic trading where a trader is processing trading instructions. These instructions are captured to the log with date/time stamps to record all or selected activity between the user application, the interface application, and the broker application.

Custom Code

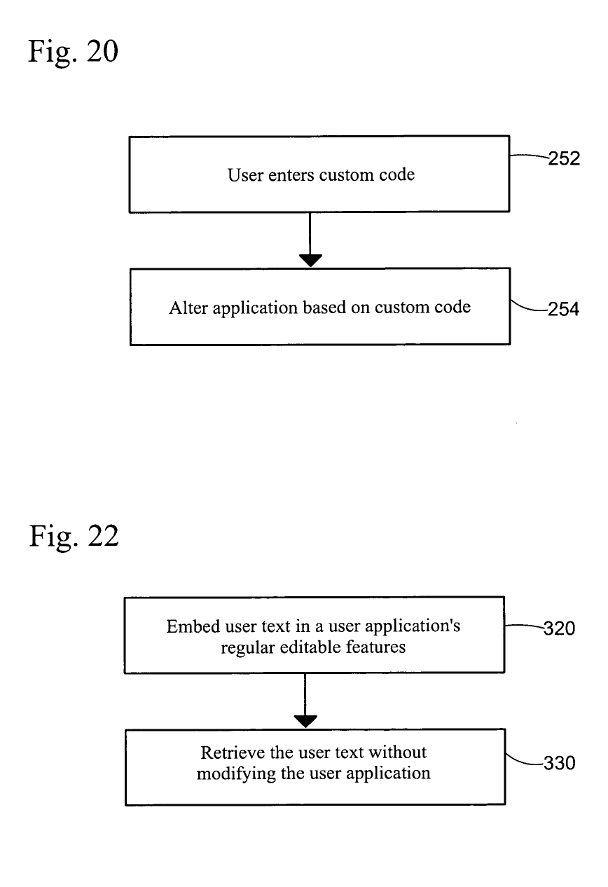

As shown in FIG. 20, this method allows the user to enter a “custom code” in the interface application in step 252, which then alters the features of the application in step 254. For example, the interface application preferably has features that are hidden or not enabled for all users, however, the features are present in the interface application. The user pays an additional fee to receive a custom code. The user then enters this custom code into the interface application. The interface application recognizes this code through a predetermined code lookup table that enables or makes visible the additional feature in the application. Other users that have not entered this code will not have the feature visible or enabled.

Feature to Monitor News

The interface application will interface to a user predetermined news website. It monitors the news and sends the news to the user application if a headline appears containing a user specified search term. For example, if the user is long IBM stock, they might specify a search term of “IBM+unexpected losses”. If the search terms were found, for the purpose of this example, the interface application would send an order to the broker application to sell IBM to offset the long position. Preferably, the user will also be immediately notified with an alarm, or E-mail, or pager, and so on.

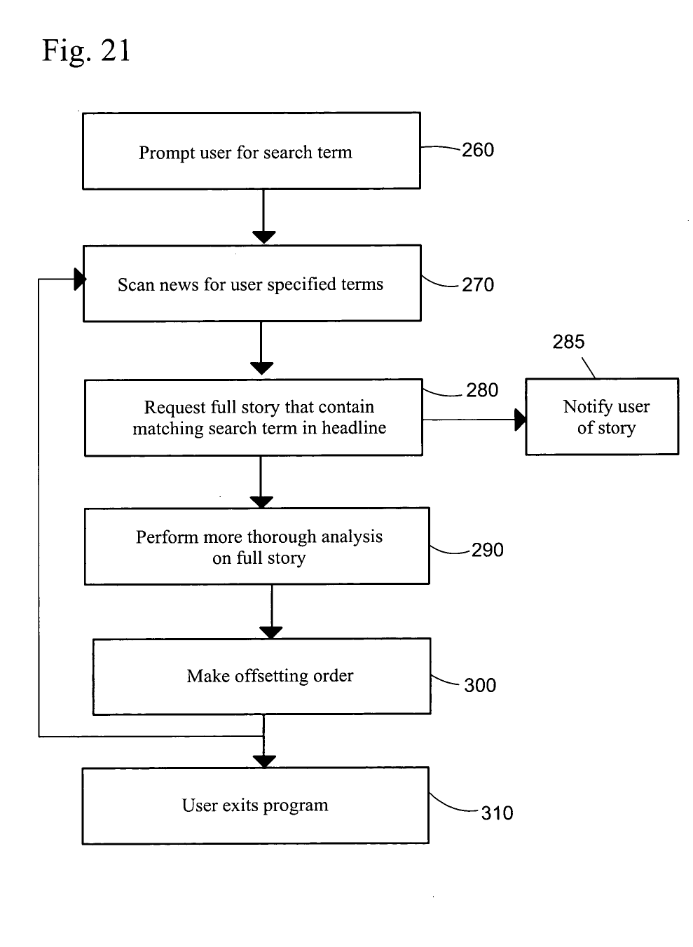

Referring to FIG. 21, the application will do the following:
Prompt user for a search term (ex. “IBM +unexpected losses”) in step 260.
Scan all news from server for user specified terms in step 270.
If the search term is found in the headline, the full story is requested in step 280.
The user can be notified that a news story of interest has been found and the details are ready to view in step 285.
A more thorough search and analysis is then performed in the full story to confirm user's intended search purpose in step 290.
Upon confirmation of search terms, the interface application sends an offsetting order to the broker application in step 300.
Go to step 270 until user exits in step 310.
   Interfacing to User Applications without Modification

Other embodiments of the present invention include methods of interfacing to user applications, without modification to that application.

Embedded Keywords & Values

This embodiment of the present invention passes user specific keywords and values from a user application to the interface application without requiring modification to the user application source or compiled code. As shown in FIG. 22, this is done, in step 320, by embedding specific text strings in the user application's regular editable features such as the filename, workspace name, signal name, window name, email, alert windows, or any other user editable text setting. The interface application then retrieves this user text passively (without modifying the user application) in step 330. Some methods of retrieving the information from the user application include, but are not limited to, hooking into a user application pop up window, email, and/or a filename.

For example, this process allows the interface application to obtain useful information from a user application (for example, TradeStation®, Metastock®, TradeLab®, etc) and bring this information into the interface application (for example, the TradeBolt™ system). The user can include in the user application workspace name (similar to a filename) specific commands such as “QtyMult=5; AutoTrade=ON; TradeSymbol=IBM;” . The interface application would receive orders with this user text and process the commands. For example, the interface application could intercept the email sent by the user application and pick up the Workspace name including user text and parse the commands from the Workspace name and process them accordingly in the interface application.

Interfacing to Other Applications to Retrieve User Specified Keywords and Values Using Window Scanning

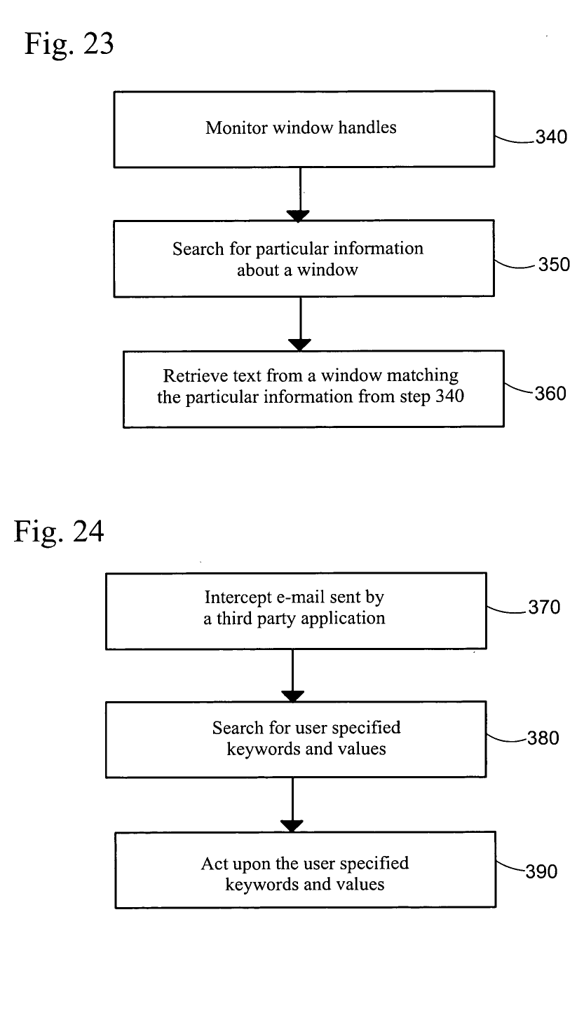

This embodiment retrieves user specified keywords and values from a user application and uses the information in the interface application. The process hooks into the user application's pop up window(s), user alert windows, or other available user application windows. As shown in FIG. 23, this is done by instructing the interface application to monitor all window handles on the computer in step 340 and scanning for information about a particular window, such as a window title, a window action, or content of a window in step 350. When the desired window is found or the action is detected, the interface application then retrieves the text from the window in step 360 and acts on it accordingly.

For example, the interface application may be scanning for a user application window titled “Active Order” with the window state of “on top” or “front” window. Once the interface application detects this window, it uses various techniques to extract all text from the window. It also looks for user embedded text such as ““QtyMult=5; AutoTrade=ON; TradeSymbol=IBM;”. If found, the interface application then acts on this information according to the keyword and value.

Interfacing to Other Applications to Retrieve User Specified Keywords and Values Using Electronic Mail (E-Mail) Interception

In another embodiment, user specified keywords and values are retrieved from a user application and the information is used in the interface application. As shown in FIG. 24, the process hooks into the user application's e-mail by intercepting the e-mail in step 370 as the user application “sends” the email. This is preferably done by creating an e-mail processor, which inserts itself between the user's regular e-mail sending processor and the user application. After intercepting the e-mail, the e-mail is searched for user specified keywords and values in step 380 and acted upon by the interface application in step 390. The e-mail can then be modified, deleted, or left intact and sent on to the user's regular e-mail processor for further processing.

For example, the interface application can insert itself as an e-mail processor between the user application and the user's regular e-mail server. All e-mail sent by the user application is then intercepted by the interface application and scanned for user embedded text such as “QtyMult=5; AutoTrade=ON; TradeSymbol=IBM;”. If found, then the interface's application acts on this information according to the keyword and value.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A method of modifying an output of a user application in communication with an interface application, comprising the steps of:
a) capturing at least one tradeable product order made by a client;
b) modifying at least one tradeable product order; and
c) sending at least one transaction record to a broker application;
wherein the interface application performs steps (a) through (c) and coordinates communication between the user application and the broker application.

2. The method of claim 1, further comprising the step of (d) transmitting at least one order to the broker application.

3. The method of claim 2, step (d) includes the substep of establishing a telecommunications link with the broker application to transmit the order to the broker application.

4. The method of claim 1, wherein step (a) includes the substep of seizing trading system transaction records.

5. The method of claim 1, wherein step (b) includes the substep of editing trading system transaction records.

6. The method of claim 1, wherein step (b) includes the substep of replacing at least one piece of data in a client specified order field with at least one second piece of data provided by the client.

7. The method of claim 1, wherein step (b) comprises the substep of cancelling all working orders.

8. The method of claim 7, wherein cancelling all working orders occurs at a time of day specified by the client.

9. The method of claim 7, wherein step (b) further comprises the substep of automatically placing orders to offset at least one of a client's tradeable product positions.

10. The method of claim 1, wherein step (b) comprises the substep of automatically placing orders to offset at least one of a client's tradeable product positions.

11. The method of claim 10, wherein placing orders to offset at least one position occurs at a time of day specified by the client.

12. The method of claim 1, further comprising the step of displaying at least one order on a client's terminal for preview before sending it to the broker application for execution.

13. The method of claim 1, wherein step (b) comprises the substep of converting a rejected stop order to a limit order when the rejected stop order is in the money.

14. The method of claim 1, wherein step (b) comprises the substep of converting a rejected stop order to a market order when the rejected stop order is in the money.

15. The method of claim 1, wherein step (b) comprises the substep of converting a stop order to a stop-limit order when the stop order is not supported by the broker application.

16. The method of claim 15, wherein step (b) further comprises the substeps of:
i) converting the stop-limit order to a market order when the stop-limit order is not supported by the broker application;
ii) retaining the market order at the interface application until a price reaches a stop price of the stop order; and
iii) placing the market order at the broker application when the price reaches the stop price.

17. The method of claim 1, further comprising the steps of:
d) the client clicking one button on the user application to instruct the interface application to convert at least one of the client's positions to flat; and
e) converting at least one of the client's positions to flat.

18. The method of claim 1, wherein step (b) includes the substeps of:
i) the client clicking one button on the user application to instruct the interface application to cancel at least one working order; and
ii) cancelling at least one working order.

19. The method of claim 1, further comprising the steps of:
d) the client clicking one button on the user application to request technical assistance; and
e) providing remote technical assistance to the client.

20. The method of claim 1, further comprising the step of creating a log of an activity of the client.

21. The method of claim 1, further comprising the step of creating a custom code.

22. A method of capturing real time prices in a price queue, comprising the steps of:
a) creating a queue of real time prices; and
b) accessing the queue, wherein a plurality of user applications can access the queue, and wherein each user application accesses the queue independent of each other and independent of a rate that the queue is adding the prices.

23. A method of compressing and sending a file, comprising the steps of:
a) compressing a file; and
b) sending the file electronically to an electronic mail address; wherein steps (a) and (b) occur when a user clicks a single button on the user application.

24. The method of claim 23, further comprising the steps of:
c) locating the file prior to step a);
d) creating an electronic mail;
e) attaching the file to the electronic mail;
f) filling out a recipient field in the electronic mail;
g) filling out a subject field in the electronic mail; and
h) filling out a body of the electronic mail with text.
wherein steps (d) through (h) are performed prior to step (b).

25. A method of interfacing between a user application and an interface application, comprising the steps of:
a) retrieving user specified keywords and values from the user application without modification to the user application; and
b) using the user specified keywords and values in the interface application.

26. The method of claim 25, further comprising, prior to step (a), the step of embedding a plurality of text strings into editable features of the user application.

27. The method of claim 26, wherein the editable features are selected from the group consisting of:
a) a filename;
b) a workspace name;
c) a signal name;
d) a window name;
e) an e-mail address;
f) an alert window; and
g) any combination of a) through f).

28. The method of claim 25, further comprising, prior to step (a), the steps of:
c) monitoring all window handles on the user application; and
d) scanning for window information selected from the group consisting of a window title, a window action, and a content of a window.

29. The method of claim 25, further comprising, prior to step (a), the steps of:
c) intercepting an electronic mail message as the user application sends the electronic mail; and
d) searching the electronic mail message for the user specified keywords and values.

30. A method of modifying an output of a user application in communication with an interface application, comprising the steps of:
a) replacing at least one piece of data in a client specified order field with at least one second piece of data provided by the client; and
b) sending the output to the broker application for execution.

31. A method of processing a request of a client on a user application in communication with an interface application, comprising the step of the interface application automatically processing at least one order request from the client.

32. The method of claim 31, comprising the substep of cancelling all working orders.

33. The method of claim 32, wherein cancelling all working orders occurs at a time of day specified by the client.

34. The method of claim 31, comprising the substep of automatically placing orders to offset at least one of a client's tradeable product positions.

35. The method of claim 34, wherein placing orders to offset at least one holding occurs at a time of day specified by the client.

36. The method of claim 31, further comprising the step of the client clicking one button on the user application to instruct the interface application to cancel at least one working order, wherein the interface application automatically processes this request by cancelling at least one working order.

37. The method of claim 36, wherein the button is located on the user application.

38. The method of claim 31, further comprising the step of the client clicking one button on the user application to instruct the interface application to convert at least one of the client's positions to flat; wherein the interface application automatically processes this request by converting at least one of the client's positions to flat.

39. The method of claim 38, wherein the button is located on the user application.

40. The method of claim 38, wherein converting the position to flat comprises the substeps of:
i) calculating an order to offset the position; and
ii) placing an order with the broker application.

41. A method of modifying an output of a user application in communication with an interface application comprising the step of displaying at least one order on a user application for preview before sending it to the broker application for execution.

42. A method of modifying an output of a user application in communication with an interface application, comprising the steps of:
a) converting a stop order, which has been rejected by a broker application, into an executable order that the broker application can fill; and
b) sending the executable order to the broker application.

43. The method of claim 42, wherein step (a) comprises the substep of converting a rejected stop order to a market order when the rejected stop order is in the money.

44. The method of claim 42, wherein step (a) comprises the substep of converting a rejected stop order to a limit order when the rejected stop order is in the money.

45. The method of claim 42, wherein step (a) comprises the substep of converting a stop order to a stop-limit order when the stop order is not supported by the broker application.

46. The method of claim 45, wherein step (a) further comprises the substeps of:
i) converting the stop-limit order to a market order when the stop-limit order is not supported by the broker application;
ii) retaining the market order at the interface application until a price reaches a stop price of the stop order; and
iii) placing the market order at the broker application when the prices reaches the stop price.

47. A method of providing technical assistance to a client on a user application in communication with an interface application, comprising the steps of:
a) the client clicking one button on the user application to request technical assistance; and
b) providing remote technical assistance to the client.

48. The method of claim 47, wherein step (b) comprises the substeps of:
a) determining if the client has installed a remote desktop program;
b) downloading the desktop program if it is not installed;
c) automatically installing the desktop program; and
d) running the program to connect the client to a source of technical support.

49. A method of monitoring an output of a user application in communication with an interface application, comprising the step of creating a log of an activity of the client.

50. The method of claim 49, comprising the substeps of:
a) capturing at least one parameter specified by the client; and
b) using the log to analyze an interaction between the client and the broker application.

51. A method of interfacing a user application with a broker application using an interface application, comprising the steps of:
a) providing a custom code to the client; and
b) allowing the client to view at least one feature in the interface application that the client could not access without the custom code.

52. The method of claim 51, wherein the client pays a fee for the custom code.

53. A method of monitoring a profit and/or a loss of at least one position in a portfolio of a client on a user application in communication with an interface application, comprising the steps of:
a) retrieving a portfolio list, which shows the profit and/or loss for each tradeable product in the portfolio; and
b) sending an order to a broker application to offset at least one tradeable product, wherein the profit or the loss of the product exceeds the profit or the loss preset by the client.

54. A method of monitoring an order status for a client on a user application in communication with an interface application, comprising the steps of:
a) retrieving a status of all of the orders from a broker application;
b) displaying the status received in step (a) to the client; and
c) acting on at least one order signal received from the user application.

55. A method of providing a client on a user application in communication with an interface application with news relevant to at least one tradeable product held by the client, comprising the steps of:
a) interfacing with at least one website, which provides news;
b) specifying at least one search term to search for on the website;
c) monitoring a plurality of headlines on the website for the search term; and
d) requesting a full story for each headline including the search term.

56. The method of claim 55, further comprising the step of notifying the client of a news story matching the search term.

57. The method of claim 55, further comprising the step of sending an order to a broker application to offset an existing tradeable product of the client, wherein the offsetting order is sent when the tradeable product is one of the search terms.

58. A computer interface system comprising an interface that can be selectively initiated by a client, wherein the interface allows a user application to communicate with a server-side trading system.

59. The computer interface system of claim 58, wherein the interface comprises a plurality of modified prerecorded HTTP commands for executing functions on the server-side trading system.

60. The computer interface system of claim 59, wherein the interface comprises computer programming code, which queries the client for parameter information for completing at least one embedded HTTP command.

61. The computer interface system of claim 58, wherein the interface comprises computer programming code, which modifies an output of the user application.

62. The computer interface system of claim 58, wherein the interface comprises computer programming code, which queries a client as to selected modifications to be made to an output of data from the user application.

63. The computer interface system of claim 58, wherein the interface comprises computer programming code, which interfaces with the server-side trading system.
